(19) United States
(12) Patent Application Publication
(10) Pub. No.: US 2005/0119898 A1
(43) Pub. Date: Jun. 2, 2005

(54) Method for processing postal objects using speech synthesis

(76) Inventor: Francis Bourgeois, Sainte Genevieve Des Bois (FR)

Correspondence Address: SUGHRUE MION, PLLC, 2100 PENNSYLVANIA AVENUE, N.W., SUITE 800, WASHINGTON, DC, 20037, US

(21) Appl. No.: 10/473,421

(22) PCT Filed: Jun. 12, 2003
(86) PCT No.: PCT/FR03/01764

(30) Foreign Application Priority Data
Jun. 19, 2002 (FR) 02/07581

(51) Int. Cl. G10L 21/00

(52) U.S. Cl. 704/275

(57) ABSTRACT

The method of processing postal objects consists in presenting an image (3) of a postal object on a video-coding station (1) and in requesting an operator (4) on the basis of said presentation to provide postal address information via the video-coding station. In this method, the operator (4) is requested by voice synthesis to read the address appearing in the image while at the same time a possible solution is spoken to the operator by voice synthesis.

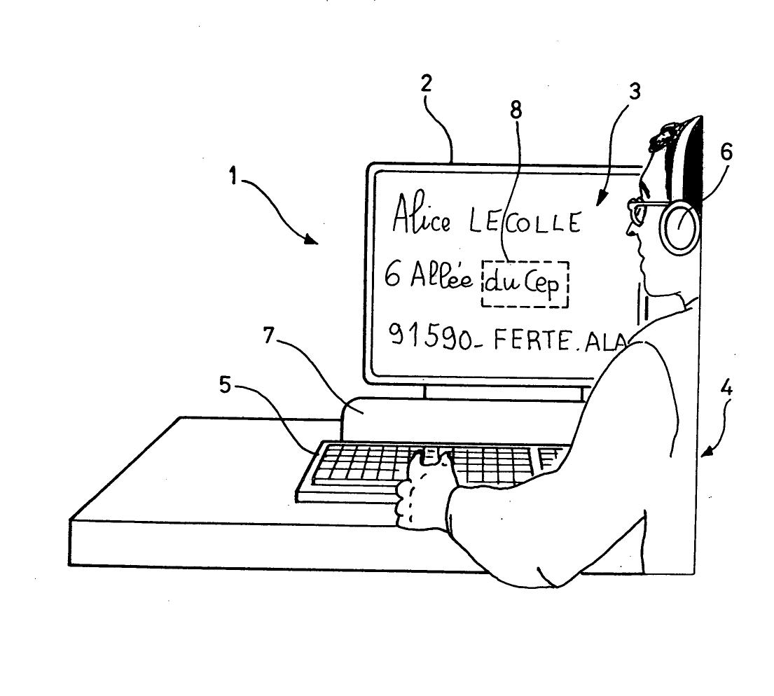

The invention relates to a method of processing postal objects, in which method an image of a postal object is presented on a video-coding station, and, on the basis of said presentation, an operator is requested to provide postal address information via the video-coding station.

A process for automatically sorting postal objects of the letter, flat object, or packet type generally includes inputting a digital image of each object. Optical character recognition (OCR) processing is then applied to said image to identify the address of the addressee appearing on the postal object. Such recognition processing can fail, i.e. it can provide a solution that has a very low confidence rating, or it can provide a plurality of solutions between which it has not been possible to choose. The term “solution” corresponds for example to a non-recognized portion of the address of the addressee: name of street, name of company or of person, number in the street, post office box number, etc.

In the event of such failure, the digital image of the object is presented on a screen of the video-coding station for an operator to provide address information, i.e. for the operator to confirm one of the proposed solutions. For this purpose, the image and the solutions are displayed simultaneously so that the operator makes the selection by comparing each solution with the address appearing in the image. In view of the high processing throughput on such a sorting installation, such an operation is tedious for the operator because, for each postal object, said operator must read the screen several times in order to provide the address information.

An object of the invention is to provide an improvement to existing video-coding methods so as to improve operator comfort and so as to reduce processing time.

To this end, the invention provides a method of processing postal objects, in which method an image of a postal object is presented on a video-coding station, and, on the basis of said presentation, an operator is requested to provide postal address information via the video-coding station, said method being characterized in that the request is spoken to the operator by voice synthesis. With this method, the operator reads the address appearing in the image at the same time as a solution is spoken to said operator by voice synthesis. Advantageously, the solution is proposed to the operator through headphones. When a plurality of solutions are possible, they are proposed by being spoken in succession to the operator.

The invention is described below in more detail and with reference to the sole FIGURE which is a diagrammatic view of a video-coding station in which the method of the invention is implemented.

The basic idea of the invention is to use voice synthesis so that the operator reads the address appearing in the image that is presented to the operator at the same time as a solution is spoken to said operator by voice synthesis.

More particularly, the sole FIGURE shows a video-coding station 1 connected to a computerized management system of a postal sorting installation, which station includes a screen 2 for displaying digital images 3 of postal objects to an operator 4. The video-coding station receives from the computerized management system one or more solutions resulting from optical character recognition processing being applied to the image 3. In the invention, the solutions are proposed to the operator by voice synthesis, so that, by comparing the address that is presented to the operator in the image 3 with the solution that is spoken to said operator, the operator 4 provides the address information by confirming or rejecting the proposed solution. Advantageously, the station is organized so that the operator can confirm the solution that is spoken by pressing on a single key of the keyboard 5.

The video-coding station may include headphones 6 connected to the central processing unit 7 to improve working conditions for the operator 4. The use of such headphones 6 makes it possible to equip the various video-coding stations present in the same video-coding room to operate with voice synthesis on each station without the operators disturbing one another.

In the example shown in the sole FIGURE, the video-coding station is a computer equipped with a voice synthesis program and connected to the headphones 6 via a sound card. The video-coding station, which is connected to the management system of the sorting installation, is thus suitable for converting the solutions resulting from the character recognition processing that are in the form of text messages into sound signals audible to the operator in the headphones 6. Such voice synthesis programs are currently available on the market. Advantageously, the voice synthesis program chosen is capable of working in a plurality of languages. In a bilingual country such as Belgium, for example, the addresses of the addressees can be written in French, or in Flemish. It is thus essential for the voice synthesis program to read in French or in Flemish, as a function of the results given by the OCR processing.

In the event that the OCR processing fails, said OCR processing can deliver a plurality of possible solutions, with a confidence rating associated with each of them. In which case, the various solutions are spoken in succession to the operator until said operator confirms the correct solution so as to resolve the ambiguity arising from the processing. Advantageously, the various solutions are spoken in order of decreasing confidence rating, so that the first solution spoken has the highest probability of being the right one. If the operator rejects all of the proposed solutions, the management system may advantageously be organized to propose to the operator to input manually the address that said operator can read from the image.

In order to improve the speed at which the operator takes in information, the address or the portion of the address that is not recognized by the processing may be framed or else extracted from the original image. With reference to the sole FIGURE, the digital image 3 corresponds to an address block in which a word corresponding to the street name 8 is framed in dashed lines so as to indicate to the operator that it is portion that remains to be identified. Thus, the speaking of the various solutions is reduced to speaking a plurality of street names, thereby saving additional time in the video-coding.

The invention may also apply to coded manual input on a video-coding station. For example, coded manual input is used when none of the proposed solutions resulting from the automatic OCR processing are confirmed by the operator. To reduce input time, the operator inputs on the keyboard only a portion of the non-recognized address line or “extract”. A management program then allocates a value to said extract, but it is possible for a plurality of solutions to correspond to the same extract. In which case, the video-coding station is organized to consult the operator by voice synthesis by speaking in succession the various solutions corresponding to the extract that the operator has input. More particularly, the various solutions are then spoken one after another until the operator confirms the solution that said operator wishes to input by using the keyboard of the station, for example.

In practice, the video-coding station 1 shown in the FIGURE is under the control of multi-tasking applications software running under the “Windows NT, 2000” operating system. This application is part of a wider set including an image server and a supervisor system that are part of the sorting system constituted by sorting machines (for letters, flat objects, and packets), automatic OCR address recognition systems, bar code readers, etc.

The supervisor system is a graphics software application of the “Windows” type, having windows and pull-down menus firstly for controlling and managing the stored images and the results base of the image server, and secondly for managing the connections and the assignments of the video-coding operators to coding tasks.

The image server receives as input the images not completely resolved by the address recognition OCR systems situated upstream in the sorting process. In the event that images are not completely resolved, the OCR systems transmit the partial results that they have succeeded in determining to the image server. As a function of the results obtained (no information, postal code, various hypotheses for the street, street determined but number in the street not determined, etc.), the image server stores, in distinct image queues, the images to be processed. This organization then makes it possible to allocate coding consoles to specific queues of images in order to make the video coding more effective. The image server submits said images to the coding consoles, and receives results in return. The results enable the image server to take a decision as to whether to continue or to stop the processing of each image. The image server stores said results in a results base for transmission to the sorting machines. The various elements of the video-coding system (supervisor software, coding console, image server) communicate with one another by interchanging messages using the Transmission Control Protocol/Internet Protocol (TCP/IP) communications protocol.

A postal database is installed in the video-coding station 1, which database is used by the video-coding software in coding tasks for resolving addresses. The postal database is identical to the database used on the OCR systems situated upstream. The voice synthesis is a facility incorporated into the video-coding software application in the form of a library which makes it possible, inter alia, to adjust the sampling frequency, the language used, and the communications protocol of the sound card.

When an operator connects to a video-coding console, the connection request made by the operator is transmitted to the supervisor system, and if the connection request is accepted, the supervisor system transmits to the console via a communications channel the list of the image queues (and therefore of the coding tasks) allocated to the console by the supervisor. Then, via another communications channel, the video-coding software in the console transmits requests to the image server for retrieving the images of addresses that are not completely resolved together with the data concerning the results of the automatic OCR processing. Such data conventionally includes the following information:
the co-ordinates in the image of the blocks of the components of the address: outward sorting line, inward sorting line, addressee line, etc.;
the information recognized automatically in said blocks: postal code, city, street, list of streets, etc.; such information is mainly in the form of text; and
the information on the type of the task to be performed by video-coding (inputting an extract of a street name, confirming a street name, etc.).

After displaying the image on the screen 2 of the video-coding station, the video-coding software extracts the information concerning the type of the task to be performed, and uses the co-ordinates of the address blocks to draw a frame (shown in the FIGURE in dashed lines) around any address information that requires processing by video coding. Said information is available in the video-coding software in text form, and is submitted to the voice synthesis library through one of its access functions so as to be played back in sound form via the headphones 6.

In parallel to the text being submitted to the voice synthesis library, the video-coding software scans the keys of the keyboard 5 that are depressed by the operator during the voice synthesis process.

With this additional voice-synthesis facility, it is possible to increase very significantly the throughput of the video-coding because the task of displaying the image is run in parallel with the task of speaking the solutions to be confirmed. Thus, it is possible to increase video-coding throughput by about 10% compared with the throughputs of video-coding systems that do not use voice synthesis.

1. A method of processing postal objects, in which method an image (3) of a postal object is presented on a video-coding station (1), and, on the basis of said presentation, an operator (4) is requested to provide postal address information via the video-coding station, said method being characterized in that the request is spoken to the operator (5) by voice synthesis.

2. A method according to claim 1, in which the request is spoken to the operator (4) by voice synthesis via headphones (6).

3. A method according to claim 1 or claim 2, in which the operator is requested by voice synthesis to resolve ambiguity in the postal address of the postal object.

4. A method according to claim 1, claim 2, or claim 3, in which the operator provides address information by depressing a single key of a keyboard (5) of the video-coding station.

5. A method according to claim 3, in which, by depressing said key of said keyboard (5), the operator confirms a solution that is spoken to said operator by voice synthesis.
